(19) United States
(12) Patent Application Publication
(10) Pub. No.: US 2017/0243428 A1
(43) Pub. Date: Aug. 24, 2017

(54) SYSTEM AND METHOD FOR DETECTING GASOCHROMIC EMISSION SPECTRA

(71) Applicant: Spectra Systems Corporation, Providence, RI (US)

(72) Inventor: Nabil Lawandy, Saunderstown, RI (US)

(21) Appl. No.: 15/449,193

(22) Filed: Mar. 3, 2017

Related U.S. Application Data
(63) Continuation-in-part of application No. 14/071,275, filed on Nov. 4, 2013, now abandoned.
Application No. 14/071,275 is a continuation-in-part of application No. 15/242,052, filed on Aug. 19, 2016.
(60) Provisional application No. 62/303,216, filed on Mar. 3, 2016.

(51) Int. Cl. G07D 7/185; G07D 7/1205; G01N 15/08

(52) U.S. Cl. CPC G07D 7/185; G01N 15/088; G07D 7/1205; G01N 15/082

(57) ABSTRACT

A detection method and system includes applying a gas to an article, the article including a gasochromic material capable of emitting a radiation emission spectrum in the presence of the gas, the article further including a first absorptive material capable of absorbing radiation in a first narrow bandwidth within the emission spectrum to produce a first narrow bandwidth absorption line in the emission spectrum, irradiating the article in the presence of the gas; and detecting the emission spectrum having the first narrow bandwidth absorption line.

### CROSS-REFERENCE TO RELATED APPLICATIONS

This application claims priority to U.S. provisional application Ser. No. 62/303,216, filed Mar. 3, 2016. This application also claims priority to U.S. non-provisional application Ser. No. 14/071,275, filed Nov. 4, 2013, and U.S. non-provisional application Ser. No. 15/242,052, filed Aug. 19, 2016, the disclosures of which are incorporated herein by reference in their entireties.

### TECHNICAL FIELD

The present invention relates generally to devices and methods for sensing the transmission of a gas or liquid through a material or membrane and for authentication of an article such as a secure instrument. More specifically, the present invention relates to the use of gasochromic materials to test the porosity or the permeability of an object, such as paper during manufacturing, and to authenticate an article, such as a secure instrument having a substrate, visual data, and a security feature.

### BACKGROUND OF THE INVENTION

High security documents such as banknotes and other paper stock have substrates formed from various porous materials such as pulp cotton fibers. Moreover, in the United States, paper currency is made from a non-woven combination of 75% cotton and 25% linen fibers. In most other countries, pulp-based substrates are used. Some countries, such as Canada, have used cotton and paper blended banknotes. In addition, countries such as Australia, New Zealand and Canada have issued banknotes having polymer substrates, e.g., substrates including biaxially oriented polypropylene. The substrate, which may include one or more plies of the substrate material, may include security features such as laminated polymer or paper security threads, planchettes, and watermarks formed directly into the substrate.

As counterfeiters have become more sophisticated, the security features in such documents have had to become more advanced as well in order to prevent widespread fraud. As the substrates of such secure documents have become more advanced, the cost to produce them has also increased, thus making the replacement of worn currency quite expensive. Therefore, it is important that in addition to being secure, such documents must have a high level of durability, lack certain imperfections, and be removed from circulation when the appropriate criteria on their fitness are available. In addition, the measurement and monitoring of porosity and permeability of various media during manufacturing is of importance to obtaining high quality product meeting the required quality level.

Banknotes are removed from circulation for a variety of reasons. In addition, based on one study, 81% of banknotes are removed because of soiling, 9% are removed because of damage caused by mechanical means, especially tearing, 5% are removed because of graffiti on the notes, 4% are removed because of general wear and tear, and 1% are removed because of damage to the security elements.

Banknotes have a finite time in circulation due to soling and tearing of the notes in use by the public. For example, it takes about 4,000 double folds (first forward and then backward) before a U.S. paper bill will tear. Banknotes are handled in many ways during their usable life and experience a variety of mechanical stresses, as well as being brought into contact with substances that can dirty the notes, resulting in difficulty in their authentication and use.

One important parameter used to determine the fitness of banknotes is limpness. When banknotes have been in circulation, the mechanical wear from folds, handling, and use in bill acceptors, results in a loss of mechanical elasticity that leads to the notes becoming limp. In addition, the mechanical wear of banknotes results in banknotes being torn and/or ripped. This “limpness,” tearing, and ripping has been shown to be directly related to changes in the porosity of the banknote with mechanical wear. In particular, the porosity of the banknotes increases with use and manifests itself in a lower effective elastic constant.

Permeability has been shown to have a correlation to limpness. Studies have also correlated permeability to deflection and stiffness. Permeability is sensitive to network deformation of a substrate, and changes in permeability, typically due to changes in porosity, can be an early indicator of the condition of the substrate network, which itself can be an early predictor of limpness. Existing methods for measuring permeability and porosity, however, are too slow for machine-readable fitness measurements.

Generally, porosity is an important physical parameter for a number of applications and as a diagnostic tool. For example, it plays a critical role in membrane separations, time released drug delivery, soil science and engineering and banknote fitness. In particular, porosity is used in a variety of fields including pharmaceuticals, ceramics, metallurgy, materials, manufacturing, earth sciences, soil mechanics, and engineering.

Typically, porosity is measured using the transport of liquids or gasses and characterizing the void fraction, physisorption, and tortuosity of the voids in a material or membrane. The detection of the gas or liquid passing through the material or membrane is measured with a variety of methods, including flow meters, mass spectrometers, absorption spectra, fluorescence, mercury intrusion, water evaporation, and mass change, computed tomography.

Specifically, with respect to banknotes, given the large numbers of banknotes in circulation for even small countries, determining the fitness of banknotes is not only of importance in cost control, but also poses a serious technical challenge in terms of processing speed and accuracy. As a result, accurate determination of the fitness of banknotes by measurement of permeability and/or porosity would be beneficial if it could be performed on the high speed sorters used by commercial and central banks to process currency for authenticity and fitness.

There is, therefore, a need to employ an efficient and accurate manner of identifying whether banknotes and lottery scratch tickets are torn, ripped, have been tampered with and/or have been subject to excessive mechanical wear based on the porosity of the documents in order to determine whether the documents should remain in circulation or be destroyed due to mechanical wear, which is directly related to the permeability changes that accompany use. There is also a need to authenticate secure instruments and other articles that contain embedded security features.

### SUMMARY OF THE INVENTION

In general, in one aspect, the invention features a detection method, including applying a gas to an article, the article including a gasochromic material capable of emitting a radiation emission spectrum in the presence of the gas, the article further including a first absorptive material capable of absorbing radiation in a first narrow bandwidth within the emission spectrum to produce a first narrow bandwidth absorption line in the emission spectrum; irradiating the article in the presence of the gas; and detecting the emission spectrum having the first narrow bandwidth absorption line.

Implementations of the invention may include one or more of the following features. The method may include authenticating the article based on the detection of the first narrow bandwidth absorption line in the emission spectrum. The gas may be capable of displacing an equilibrium concentration of oxygen in the gasochromic material.

The article may include a second absorptive material capable of absorbing radiation in a second narrow bandwidth within the emission spectrum to produce a second narrow bandwidth absorption line in the emission spectrum, and the method may further include detecting the emission spectrum having the second narrow bandwidth absorption line. The method may include authenticating the article based on the detection of the first narrow bandwidth absorption line and the second bandwidth absorption line in the emission spectrum. The authenticating may include comparing the wavelengths of relative minima of the first narrow bandwidth absorption line and the second narrow bandwidth absorption line in the spectrum. The first narrow bandwidth absorption line may have a first intensity corresponding to a first diminution of the emission spectrum and the second narrow bandwidth absorption line has a second intensity corresponding to a second diminution of the emission spectrum, and the authentication may include determining a ratio of the first intensity and the second intensity.

In general, in another aspect, the invention features a detection system, including a gas source for applying a gas to an article, the article including a gasochromic material capable of emitting a radiation emission spectrum in the presence of the gas, the article further including a first absorptive material capable of absorbing radiation in a first narrow bandwidth within the emission spectrum to produce a first narrow bandwidth absorption line in the emission spectrum; an excitation source for irradiating the article in the presence of the gas; and a detection device for detecting the emission spectrum having the first narrow bandwidth absorption line.

Implementations of the invention may include one or more of the following features. The system may include a processor for authenticating the article based on the detection of the narrow bandwidth absorption line in the emission spectrum. The article may be a label, or a secure instrument or a banknote. The gasochromic material may be disposed within the article or on the article. The absorptive material may be disposed in the gasochromic material or on the gasochromic material. The excitation source may provide visible light radiation or non-visible electromagnetic radiation. The detection device may be an imaging device, a camera, a cellphone or a tablet.

The article may include a second absorptive material capable of absorbing radiation in a second narrow bandwidth within the emission spectrum to produce a second narrow bandwidth absorption line in the emission spectrum, and the detection device may detect the first narrow bandwidth absorption line and the second bandwidth absorption line in the emission spectrum. The processor may be capable of authenticating the article by comparing the wavelengths of relative minima of the first narrow bandwidth absorption line and the second narrow bandwidth absorption line in the spectrum. The first narrow bandwidth absorption line has a first intensity corresponding to a first diminution of the emission spectrum and the second narrow bandwidth absorption line has a second intensity corresponding to a second diminution of the emission spectrum, and the processor may be capable of authenticating the article by determining a ratio of the first intensity and the second intensity.

### BRIEF DESCRIPTION OF THE DRAWINGS

The above-mentioned and other aspects, features and advantages can be more readily understood from the following detailed description with reference to the accompanying drawings, wherein:

FIG. 1 is a diagram of an apparatus for testing the porosity or the permeability of an object, such as a banknote, according to an embodiment of the present disclosure;

FIG. 2 is diagram of an apparatus for testing the porosity or the permeability of an object according to an embodiment of the present disclosure;

FIG. 3 is a diagram of a substrate with embedded gasochromic materials according to an embodiment of the present invention;

FIGS. 4A and 4B are graphs showing the emission spectra of gasochromic molecules in response to contact with a fluid rich in oxygen and a fluid containing substantially no oxygen, respectively;

FIGS. 5A and 5B are graphs showing a comparison of the emission spectra of a gasochromic material to compare the porosity of an uncirculated banknote and a circulated banknote, respectively;

FIG. 6 shows the porosity and permeability of certain substrates;

FIG. 7 is a graph comparing permeability to stiffness;

FIG. 8 is a graph comparing permeability to limpness;

FIG. 9 is a graph showing the emission spectrum of a gasochromic material upon the application of a fluid according to an embodiment of the present invention;

FIG. 10 is a graph showing the emission spectrum of a gasochromic material without the application of a fluid according to an embodiment of the present invention;

FIG. 11 is a graph showing the emission spectrum of a gasochromic material including an absorptive material that produces a narrow band absorption line in the emission spectrum;

FIG. 12 is a graph showing the emission spectrum of a gasochromic material including two different absorptive materials that produce two narrow band absorption lines in the emission spectrum.

### DETAILED DESCRIPTION OF THE PREFERRED EMBODIMENTS

The present invention provides for apparatus and methods for sensing the transmission of a gas or liquid through an article, object, material, or membrane. More specifically, the present invention provides for methods and apparatus for measuring the porosity or the permeability of secure instruments, such as banknotes in order to determine whether the secure instruments are ripped, have a tear, have been tampered with, or have been exposed to a high amount of mechanical wear. It should be noted, however, that the present invention should not be limited to use with secure instruments. The present invention may be used to measure the porosity or the permeability of any desired object, material, or membrane.

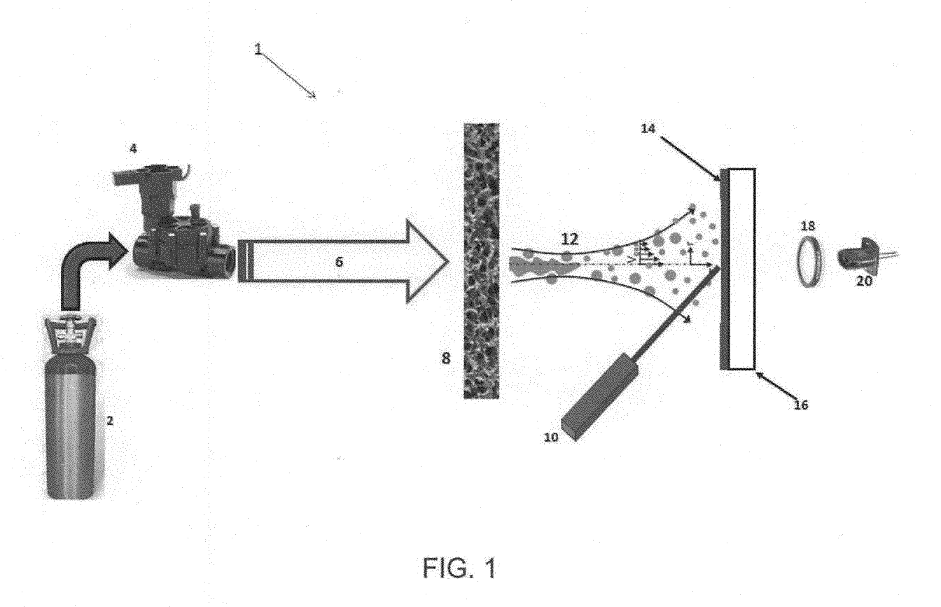

FIG. 1 illustrates a diagram of an apparatus 1 for testing the porosity or the permeability of a secure instrument 8, according to an embodiment of the present disclosure. The apparatus 1 may include a fluid container 2, a fluid dispenser or source 4. The fluid source 4 may be any device known to those skilled in the art that is configured to dispense, direct, and/or control the flow of a fluid (i.e., a liquid or a gas) including, but not limited to, a pump and a line gas source. In the embodiment of FIG. 1, for example, the fluid source 4 may be a valve. The fluid source 4 may be powered by any means known to those skilled in the art, including but not limited to, electric, hydraulic, motor, pneumatic, and manual. In addition, the fluid source 4 may include multiple fluid dispensing outlets. Alternatively, as illustrated in FIG. 1, the fluid source 4 may include a single dispensing outlet 6.

The fluid source 4 may be connected to a fluid container 2. The fluid container 2 may hold any fluid (i.e., liquid or gas) known to those skilled in the art that is capable of displacing an equilibrium concentration of oxygen in a gasochromic material 14 upon contact with the gasochromic material 14. For example, the fluid may be any liquid or gas that is rich in oxygen. Alternatively, the fluid may be any liquid or gas that contains substantially no oxygen, including, but not limited to argon, helium, xenon, and nitrogen.

As previously discussed, the fluid may be capable of displacing the equilibrium concentration of oxygen in the gasochromic material 14. The gasochromic material 14 may be any material configured to change the intensity or spectral position of its emission or absorption bands in response to various molecular moieties. For example, the gasochromic material 14 may be any desired low molecular weight polymer material known to those skilled in the art that contains gasochromic molecules. The gasochromic molecules may be any molecules configured to emit light under excitation by UV light or other wavelengths including, but not limited to, platinum, rhodium, Pt-porophyrines, and iridium containing phosphyrines and nano-crystalline zinc-oxide. For example, in one embodiment, the gasochromic material 14 may be a low molecular weight polymer coating, such as polystyrene (PS), containing gasochromic molecules. Alternatively, in an alternative embodiment, the gasochromic material 14 may be embedded in the substrate 16.

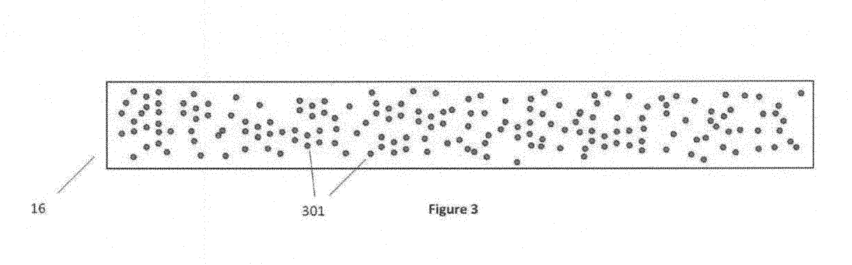

As shown in FIG. 3, in one embodiment, the gasochromic material may be embedded in the substrate 16. For example, the gasochromic material 301 can be embedded throughout the thickness of the substrate 16. According to certain exemplary embodiments, the embedded gasochromic material can include gasochromic elements, such as particles, dissolved molecules, or security features, or can also include material embedded into the substrate 16 in the sizing material used in the manufacture of paper and/or the adhesives used to secure security threads inside the substrate 16. As described herein, the porosity or the permeability of the substrate is related to the output of the excited gasochromic material embedded in the substrate 16.

Embedding the gasochromic materials throughout the substrate 16 can further enable the porosity or the permeability of the substrate 16 to be tested from both sides of the substrate 16. Embedding the gasochromic materials throughout the substrate 16 can also enable high speed testing of the porosity or the permeability of the substrate 16. Moreover, changes in the porosity or permeability of the substrate can be determined based on the output of excited gasochromic elements embedded in the substrate 16.

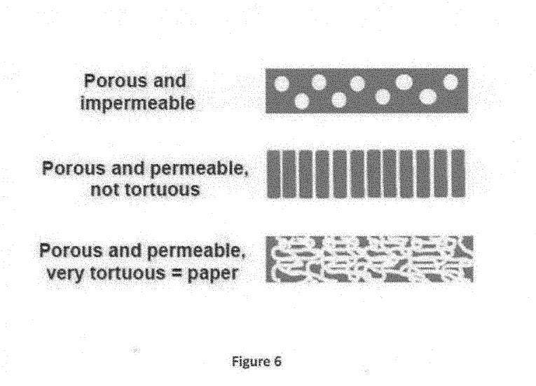

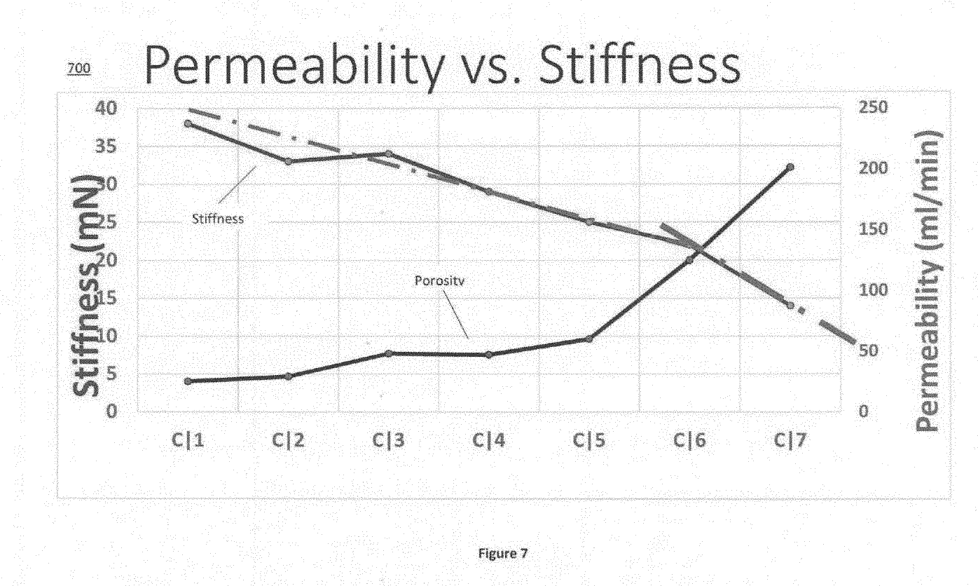

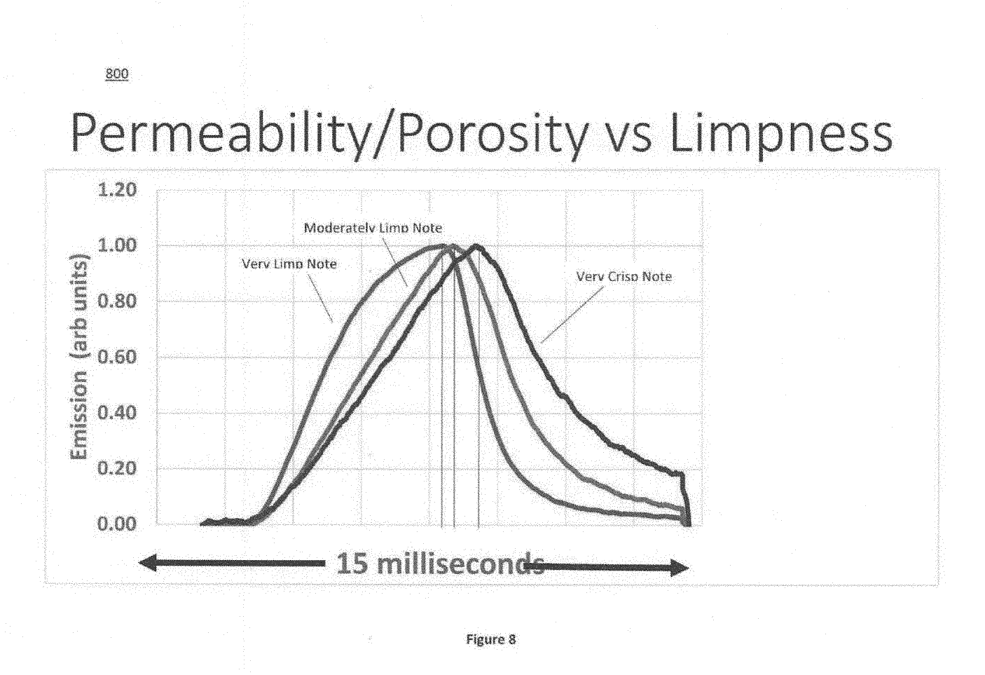

Further, embedding the gasochromic elements in the substrate 16 may also enable detection of changes in the substrate 16, such as limpness. FIG. 6 shows the porosity and permeability of various substances. For example, FIG. 6 shows examples of: (1) a porous and impermeable substrate; (2) a porous and permeable, not tortuous, substrate; and (3) a porous and permeable, very tortuous, substrate, which may be paper. FIG. 7 shows a graph 700 comparing the stiffness of a substrate to the permeability/porosity of the substrate. FIG. 8 shows a graph 800 comparing the permeability/porosity to the limpness of a note, and shows the emission characteristics of three notes: (1) a very limp note; (2) a moderately limp note; and (3) a very crisp note.

As previously discussed, the gasochromic material 14 may be configured to emit light under excitation. FIG. 1 illustrates that excitation of the gasochromic material 14 may be accomplished via an excitation source 10. The excitation source 10 may be any device configured to emit light that is capable of causing the gasochromic molecules in the gasochromic material 14 to emit a phosphorescent transition from a triplet state to a singlet ground state. For example, the excitation source 10 may be an LED or a lamp. Alternatively, as illustrated in FIG. 1, the excitation source may be a laser.

When the gasochromic molecules in the gasochromic material 14 are in an excited state, the light emitted may be sensed by a detection device 20, which is part of the apparatus 1. The detection device 20 may be any device known to those skilled in the art that may be configured to sense light, capture images, and/or create images. In one embodiment, for example, the detection device 20 may include an imaging device, such as a camera, a cellphone or a tablet. In addition, or alternatively, the detection device 20 may include at least one sensor (not shown) configured to sense the emitted light. The sensors may be any sensors known to those skilled in the art including, but not limited to, photodiodes, photomultipliers, and photovoltaic cells.

FIG. 1 further illustrates that the detection device 20 may include one or more filters 18. The filter 18 may be any device known to those skilled in the art configured to reject all light other than the light emitted from the gasochromic molecules. For example, in one embodiment, the filter may be a Schott red glass 610 (RG 610).

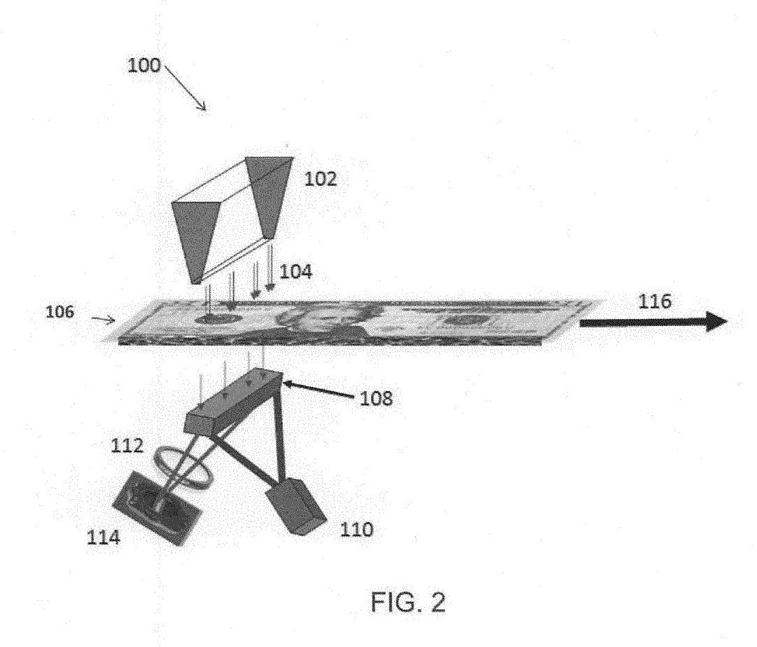

FIG. 2 illustrates a diagram of an apparatus 100 for testing the porosity or the permeability of a secure instrument 106 according to another embodiment of the present disclosure. The apparatus 100 of FIG. 2 may include features that are similar to the apparatus of FIG. 1. For example, the apparatus may include a fluid dispenser or source 102 configured to dispense a fluid (i.e., a liquid or a gas). The fluid source 102 may be any fluid source known to those skilled in the art that is configured to direct a flow of the fluid along a width of the secure instrument 106 as the secure instrument is advanced along its longitudinal axis 116. For example, as illustrated in FIG. 2, the fluid source 102 may be a line gas source. The fluid source 102 may further include any desired number of dispensing outlets 104 known to those skilled in the art. For example, as illustrated in FIG. 2, the fluid source 102 may contain a single dispensing outlet 104 extending along the length of the fluid source 102, and configured to extend along the width of the secure instrument 106.

Similar to FIG. 1, the fluid may be any liquid or gas configured to displace the equilibrium concentration of oxygen in a gasochromic material 108, such as a liquid or gas rich in oxygen or a liquid or gas containing substantially no oxygen. In the embodiment of FIG. 2, for example, the fluid may be a gas capable of being dispensed through the line gas source.

The apparatus 100 of FIG. 2 may further include a gasochromic material 108 mounted on a substrate that may be configured to enable a detection device 114 to sense light emitted from the gasochromic material 108 disposed on a transparent substrate. Like the gasochromic material 14 of FIG. 1, the gasochromic material of FIG. 2 may include a plurality of gasochromic molecules capable of emitting light upon receipt of light from an excitation source 110. The gasochromic material 108 may be any low molecular weight material, such as a film, that includes gasochromic molecules. The gasochromic material may be particles, molecules, security features, or other materials embedded in a substrate.

The excitation source 110 of FIG. 2 may also be similar to the excitation source 10 of FIG. 1. For example, the excitation source 110 may be an LED, a lamp, or, as illustrated in FIG. 2, a laser. The excitation source 110 may further be configured to direct light along a single path. Alternatively, the excitation source 110 may be configured to emit light along any desired number of optical pathways known to those skilled in the art. For example, as illustrated in FIG. 2, the excitation source 110 may be configured to emit light along at least two pathways.

The apparatus 100 of FIG. 2 further includes a detection device 114. Like the detection device 20 of FIG. 1, the detection device 114 of FIG. 2 may include at least one filter 112 configured to reject all light other than the light emitted from the gasochromic molecules in the gasochromic material 108. In addition, the detection device 114 may include any device known to those skilled in the art that may be configured to sense light, capture images, and/or create images. The detection device 114 may also include at least one sensor (not shown) configured to sense the emitted light. The sensors may be any sensors known to those skilled in the art including, but not limited to, photodiodes, photomultipliers, and photovoltaic cells. For example, in the embodiment of FIG. 2, the detection device 114 may be a line scan camera. In addition, as illustrated in FIG. 2, the detection device 114 may be configured to obtain a plurality of images of the light emitted from the gasochromic molecules as the secure instrument 106 is advanced through a space between the fluid source 102 and the gasochromic material 108 along the longitudinal axis 116 of the secure instrument 106.

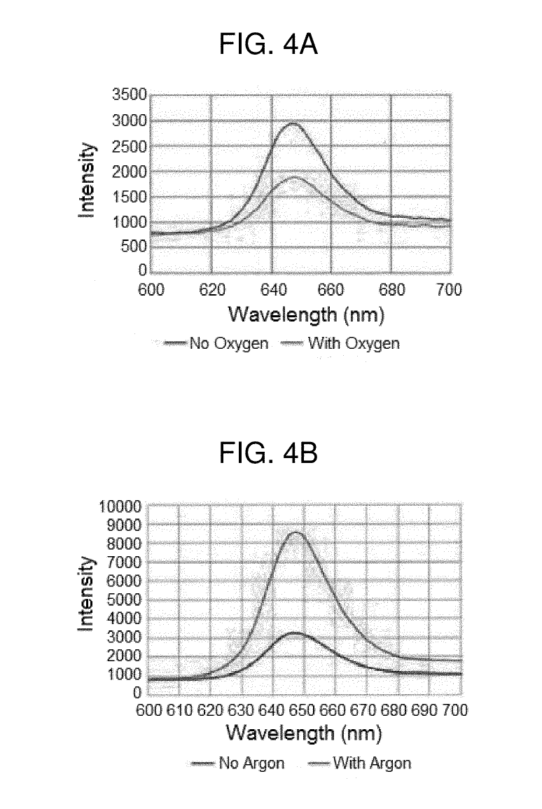

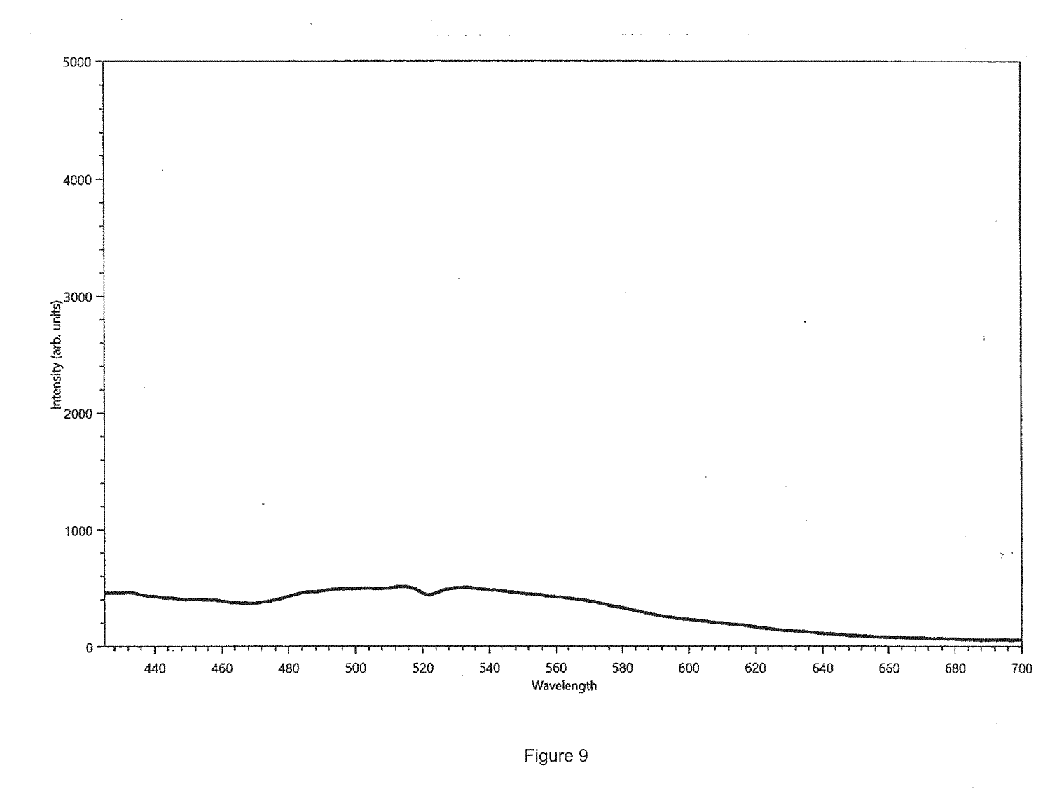

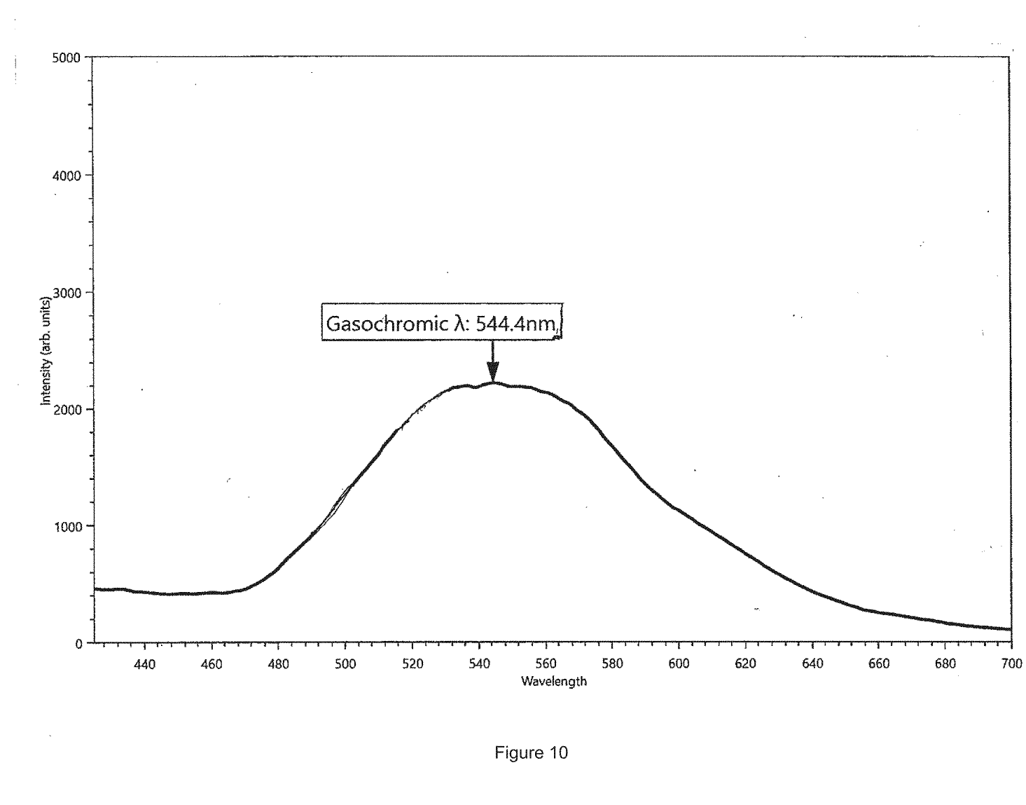

The apparatus 1 of FIG. 1 and the apparatus 100 of FIG. 2 may also each include a processor (not show) known to those skilled in the art. The processor may be configured to receive the detected images from the detection devices and output porosity or permeability data based on the detected images. The porosity or permeability data may include data corresponding to the light emitted from the gasochromic molecules in the gasochromic material 14, 108. As shown in FIG. 9, the gasochromic material emits a spectrum of light upon the application of a fluid according to an embodiment of the present invention. FIG. 9 shows the relative intensities (using arbitrary units) of the light emitted from the gasochromic material upon the application of a fluid as a function of the wavelength of the light. In the example of FIG. 9, the light emitted from the gasochromic material upon the application of a fluid according to an embodiment of the invention is centered around and has a maximum intensity at a wavelength λ of 544.4 nm with a wide bandwidth of 101.1 nm. For comparison purposes, as shown in FIG. 10, the spectrum of light emitted from the gasochromic material without the application of a fluid according to an embodiment of the present invention does not produce a wide bandwidth spectrum of intensities centered around a particular wavelength. For example, as illustrated in FIG. 4A, when a fluid that is rich in oxygen is dispensed to flow through the secure instrument 8, 106, the light that is emitted from the gasochromic material is inversely related to the porosity of the material: a lower detection of emitted light corresponds to a higher level of porosity. Conversely, as illustrated in FIG. 4B, when a fluid that has substantially no oxygen is dispensed to flow through the secure instrument 8, 106, the detected emitted light is directly related to the porosity of the material: a lower detection of emitted light corresponds to a lower level of porosity.

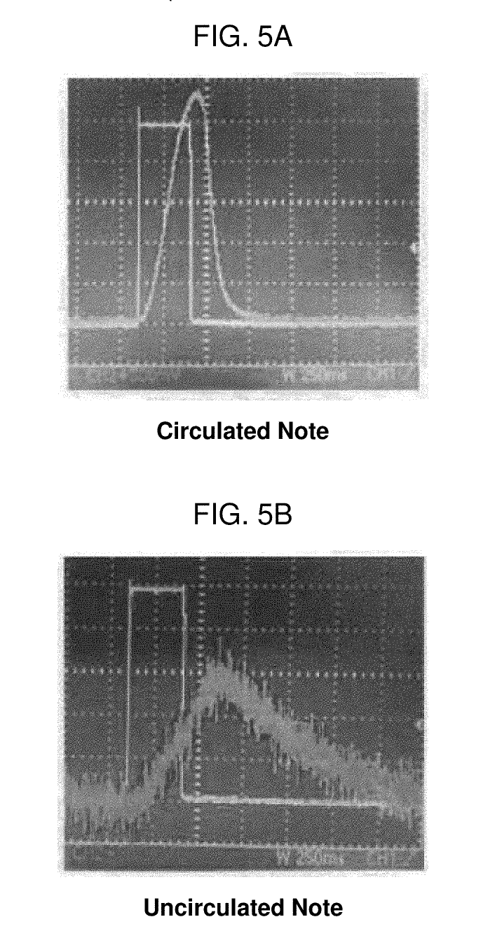

FIGS. 5A and 5B illustrate porosity data of a circulated banknote (FIG. 5A) and an uncirculated banknote (FIG. 5B) that have been tested using the apparatus of FIG. 1 with fluid containing substantially no oxygen. Typically, uncirculated banknotes have a lower porosity than circulated banknotes, because the uncirculated banknotes have not been exposed to mechanical wear. The porosity data shown in FIGS. 5A and 5B is consistent with this fact. As illustrated in FIGS. 5A and 5B, the porosity test of the circulated banknote (FIG. 5A) detected more emitted light from the gasochromic material than the porosity test of the uncirculated banknote (FIG. 5B).

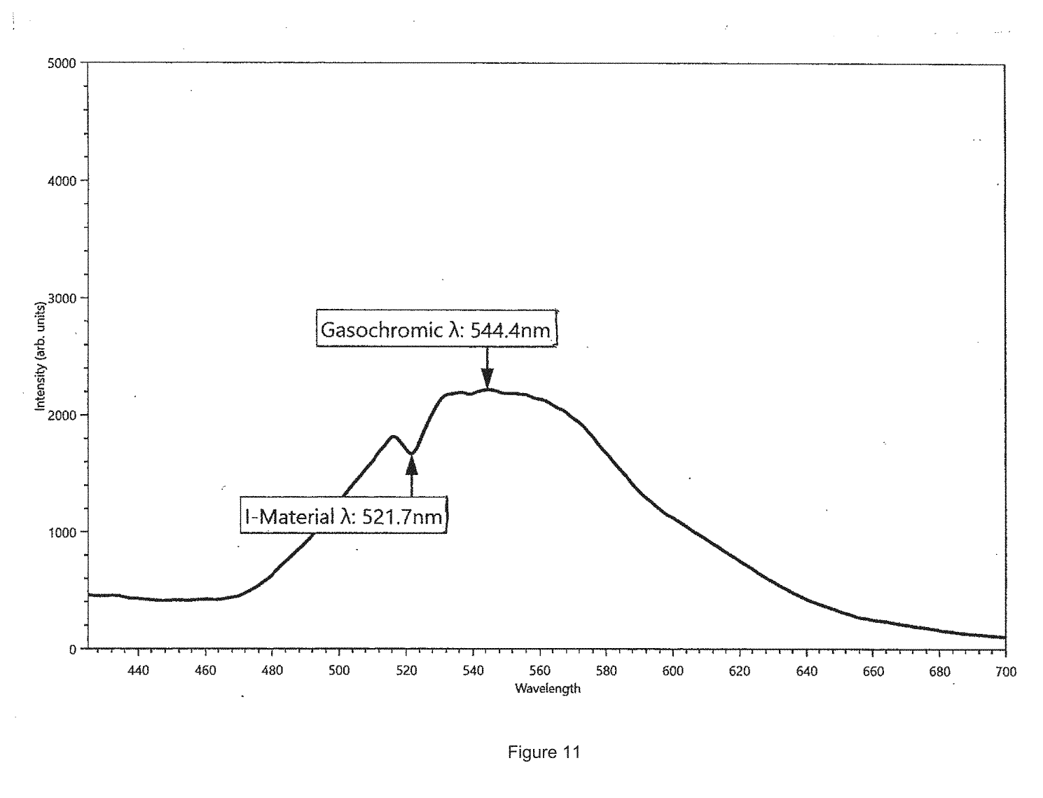

The gasochromic material as generally described herein may also be used for authentication of an article such as a secure instrument or banknote. The gasochromic material may be disposed on or within the article, including in the form of security features embedded in the substrate of the article. The gasochromic material may further include one or more absorptive materials that produce narrow bandwidth absorption lines in the emission spectrum of the gasochromic material. The bandwidth of the absorption lines is preferably less than 5 nm. The absorptive material may include modified rare earth compounds that produce narrow bandwidth absorption lines within a wide band emission spectrum of the gasochromic material. The absorptive material may be found in one or more layers on one surface of the gasochromic material, or may be disposed in or dispersed throughout the gasochromic material itself. In the example of FIG. 11, the emission spectrum of the gasochromic material with an absorptive material includes a narrow bandwidth absorption line centered around and having a minimum intensity at a wavelength λ₁ of 521.7 nm with a bandwidth of 4.7 nm.

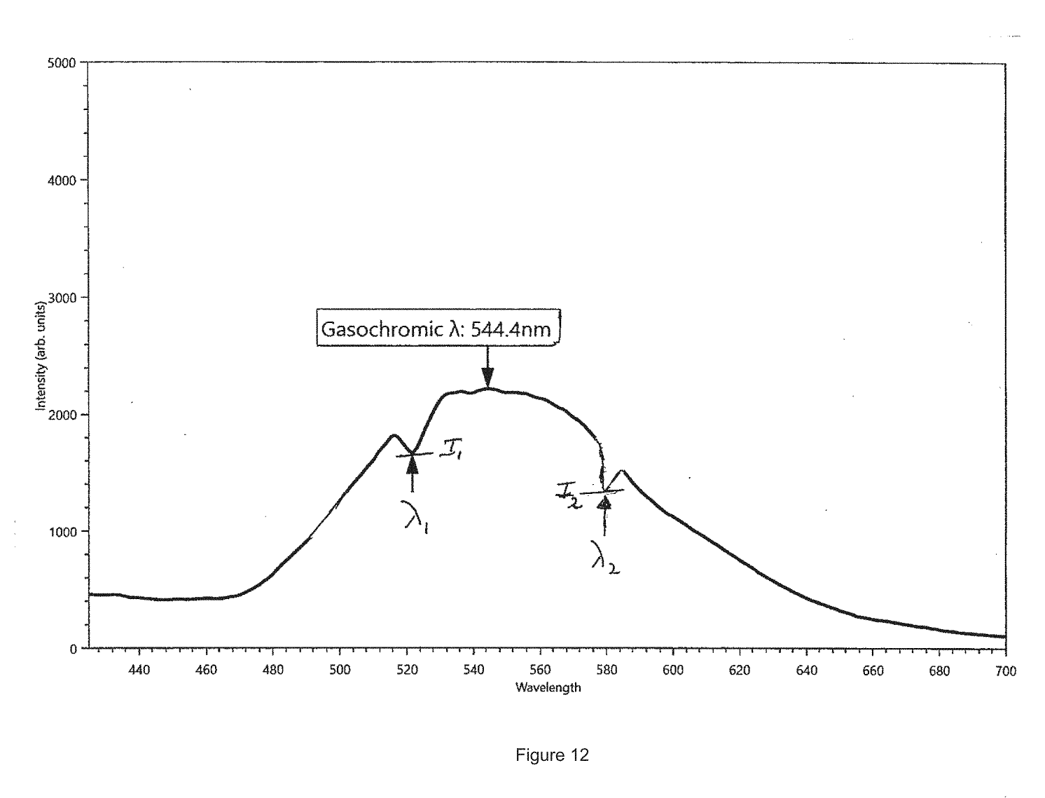

The presence of the gasochromic material with the absorptive material may be an authenticating feature of the article. Thus, the detection of the resultant emission spectrum from the combined gasochromic material and absorptive material upon excitation with a specified fluid source is a method of authenticating the article. A gasochromic material without added absorptive material will produce an emission spectrum as shown in FIG. 10, while the inclusion of absorptive material with the gasochromic material produces a distinctive emission spectrum as shown in FIG. 12. In addition, the relative diminution of the emission spectrum of the gasochromic material at the narrow bandwidth absorption line, as measured by the intensity of the wavelength corresponding to the minimum intensity of the absorption line, is an additional indicator for determining the authenticity of the article.

In another embodiment, the gasochromic material may include more than one absorptive material that produces corresponding separate, narrow bandwidth absorption lines in the emission spectrum of the gasochromic material. For example, the gasochromic material may include two different absorptive materials that produce two different narrow bandwidth absorption lines in the emission spectrum of the gasochromic material. In the example of FIG. 12, the emission spectrum of the gasochromic material includes two narrow bandwidth absorption lines at wavelengths λ₁ and λ₂ with intensities I₁ and I₂, respectively. In the case of the gasochromic material including more than one absorptive material that produces narrow bandwidth absorption lines in the emission spectrum of the gasochromic material, the relative positions of the wavelengths of the minima of the absorption lines in the emission spectrum of the gasochromic material, as well as the ratios of the diminution of the emission spectrum at the narrow bandwidth absorption lines (as measured by the ratio of their relative intensities), are additional indicators that may be used to determine the authenticity of an article that is intended to contain the combination of gasochromic material and absorptive material that produces the resulting detected spectra.

Referring back to FIGS. 1 and 2, the present disclosure includes a method of testing the porosity of an object, material, or membrane. The method may first include positioning the object, material, or membrane in a space between the fluid source 4, 102 and the gasochromic material 14, 108. In the embodiment of FIG. 1, the object, material, or membrane may be positioned such that it may be secured between the fluid source 4 and the gasochromic material 14. For example, apparatus 1 may include a device configured to maintain the material or membrane in a substantially flat position, such as a plate (not shown). The device (i.e., plate) may also be configured to attach to the fluid source 4 and enable the fluid source 4 to dispense the fluid through the material or membrane. Alternatively, as illustrated in FIG. 2, the object, material, or membrane may be positioned such that the object, material, or membrane may be advanced along its longitudinal axis 116, and thereby movable relative to the fluid source 102, the gasochromic material 108, and the detection device 114.

As previously discussed, the object, material, or membrane may be any sample where porosity testing is desired. Samples may be used from a variety of fields including, but not limited to, pharmaceuticals, ceramics, metallurgy, materials, manufacturing, earth sciences, soils mechanics, and engineering. The embodiments of FIGS. 1 and 2 illustrate that the object, material, or membrane sample may in the form of a secure instrument 8, 106. The secure instrument 8, 106 may be a banknote having a substrate, visual data, and a security feature. The banknote may be any banknote from any country, including but not limited to, banknotes from the United States, China, Europe, Russia, Canada and India.

Returning to FIGS. 1 and 2, after the object, material, or membrane is positioned in the space between the fluid source 4, 102 and the gasochromic material 14, 108, fluid may be dispensed through the outlets 6, 104 of the fluid source 4, 102 such that at least a portion of the dispensed fluid 12 can flow through the object, material, or membrane. As illustrated in FIGS. 1 and 2, fluid that flows completely through the object, material, or membrane may contact the gasochromic material 14, 108 and may quench light emission of the gasochromic molecules in the gasochromic material 14, 108. In particular, FIG. 1 illustrates that the portion of the dispensed fluid 12 that flows from a side of the secure instrument 8 facing the fluid source 4 to a side of the secure instrument 8 facing the gasochromic material 14 may disperse along a width of the gasochromic material 14. For example, as illustrated in FIG. 1, at least some of the portion of the dispensed fluid 12 may disperse in a direction substantially perpendicular to a flow path of the fluid through the secure instrument 8.

The method further includes powering the excitation source 10, 110, such that the excitation source 10, 110 may emit UV or other wavelengths configured to excite the gasochromic molecules in the gasochromic material 14, 108. The excitation source 10, 110 may be positioned such that at least one path of light from the excitation source intersects with the gasochromic material 14, 108. In addition, the excitation source 10, 110 may be powered prior to, during, and after the fluid contacts the gasochromic material 14, 108, so that the detection device may be capable of detecting emitted light corresponding to the equilibrium concentration of oxygen in the gasochromic material 14, 108, and emitted light corresponding to the displaced equilibrium concentration of oxygen in the gasochromic material 14, 108. Thus, the porosity of the object, material, or membrane is related to the change in the detected emitted light corresponding to the equilibrium concentration of oxygen in the gasochromic material 14, 108 and the detected emitted light corresponding to the displaced equilibrium concentration of oxygen in the gasochromic material 14, 108.

During excitation of the gasochromic molecules in the gasochromic material 14, 108, the detection device 20, 114 may be detecting the emitted light by first, using the filter 18, 112 to reject all light other than the light emitted from the gasochromic molecules. After filtering the light, the detection device 20, 114 may use the sensors therein to detect the emitted light. The detection device 20, 114 may further transmit the detected light signals to the processor (not shown), which may be configured to determine and output data corresponding to the porosity and thereby the fitness (e.g., mechanical wear, rips, pinpricks, and tears) of the object, material, or membrane used in conjunction with the apparatus 1, 100 by analyzing the information received from the detection device 20, 114.

The determination and output of data corresponding to the porosity of the object, material or membrane may be calculated based on an average porosity over the entire material or membrane. For example, in the embodiment of FIG. 1, the secure instrument 8 may be secured between the fluid source 4 and the gasochromic material 14; and the fluid source 4 may be configured to dispense the fluid on the secure instrument 8 such that a porosity determination may be made across the entire note.

Alternatively, porosity may be determined along the length of the banknote 106. As illustrated in FIG. 2, the secure instrument 106 may be positioned in a space between the fluid source 102 and the gasochromic material 108. The secure instrument 106 may be advanced through the space along its longitudinal axis 116. As the secure instrument 106 is advanced through the space, the fluid source 102 may dispense fluid along the length of the secure instrument 106, such that the detection device 114 may obtain data corresponding to the porosity of the secure instrument 106 along its length.

The embodiments and examples above are illustrative, and many variations can be introduced to them without departing from the spirit of the disclosure or from the scope of the invention. For example, elements and/or features of different illustrative and exemplary embodiments herein may be combined with each other and/or substituted with each other within the scope of this disclosure. For a better understanding of the invention, its operating advantages and the specific objects attained by its uses, reference should be had to the accompanying drawings and descriptive matter in which there is illustrated a preferred embodiment of the invention.

What is claimed is:

1. A detection method, comprising:
applying a gas to an article, the article including a gasochromic material capable of emitting a radiation emission spectrum in the presence of the gas, the article further including a first absorptive material capable of absorbing radiation in a first narrow bandwidth within the emission spectrum to produce a first narrow bandwidth absorption line in the emission spectrum;
irradiating the article in the presence of the gas; and
detecting the emission spectrum having the first narrow bandwidth absorption line.

2. The method of claim 1, further comprising
authenticating the article based on the detection of the first narrow bandwidth absorption line in the emission spectrum.

3. The method of claim 1, wherein the gas is capable of displacing an equilibrium concentration of oxygen in the gasochromic material.

4. The method of claim 1, wherein the article includes a second absorptive material capable of absorbing radiation in a second narrow bandwidth within the emission spectrum to produce a second narrow bandwidth absorption line in the emission spectrum; and further comprising
detecting the emission spectrum having the second narrow bandwidth absorption line.

5. The method of claim 4, further comprising
authenticating the article based on the detection of the first narrow bandwidth absorption line and the second bandwidth absorption line in the emission spectrum.

6. The method of claim 5, wherein the authenticating includes comparing the wavelengths of relative minima of the first narrow bandwidth absorption line and the second narrow bandwidth absorption line in the spectrum.

7. The method of claim 5, wherein the first narrow bandwidth absorption line has a first intensity corresponding to a first diminution of the emission spectrum and the second narrow bandwidth absorption line has a second intensity corresponding to a second diminution of the emission spectrum; and
wherein the authentication includes determining a ratio of the first intensity and the second intensity.

8. A detection system, comprising:
a gas source for applying a gas to an article, the article including a gasochromic material capable of emitting a radiation emission spectrum in the presence of the gas, the article further including a first absorptive material capable of absorbing radiation in a first narrow bandwidth within the emission spectrum to produce a first narrow bandwidth absorption line in the emission spectrum;
an excitation source for irradiating the article in the presence of the gas; and
a detection device for detecting the emission spectrum having the first narrow bandwidth absorption line.

9. The system of claim 8, further comprising
a processor for authenticating the article based on the detection of the narrow bandwidth absorption line in the emission spectrum.

10. The system of claim 8, wherein the article is a label.

11. The system of claim 8, wherein the article is a secure instrument or a banknote.

12. The system of claim 8, wherein the gasochromic material is disposed within the article or on the article.

13. The system of claim 8, wherein the absorptive material is disposed in the gasochromic material or on the gasochromic material.

14. The system of claim 8, wherein the excitation source provides visible light radiation or non-visible electromagnetic radiation.

15. The system of claim 8, wherein the detection device is an imaging device, a camera, a cellphone or a tablet.

16. The system of claim 8, wherein the article includes a second absorptive material capable of absorbing radiation in a second narrow bandwidth within the emission spectrum to produce a second narrow bandwidth absorption line in the emission spectrum; and
wherein the detection device detects the first narrow bandwidth absorption line and the second bandwidth absorption line in the emission spectrum.

17. The system of claim 16, wherein the processor is capable of authenticating the article by comparing the wavelengths of relative minima of the first narrow bandwidth absorption line and the second narrow bandwidth absorption line in the spectrum.

18. The system of claim 16, wherein the first narrow bandwidth absorption line has a first intensity corresponding to a first diminution of the emission spectrum and the second narrow bandwidth absorption line has a second intensity corresponding to a second diminution of the emission spectrum; and
wherein the processor is capable of authenticating the article by determining a ratio of the first intensity and the second intensity.
